(19) United States
(12) Patent Application Publication
(10) Pub. No.: US 2007/0170005 A1
(43) Pub. Date: Jul. 26, 2007

(54) Machine room-less elevator

(75) Inventors: Hiroshi Kigawa, Tokyo (JP); Takashi Yumura, Tokyo (JP); Kenichi Okamoto, Tokyo (JP); Hideaki Kodera, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku, Tokyo (JP)

(21) Appl. No.: 10/586,864

(22) PCT Filed: Feb. 17, 2005
(86) PCT No.: PCT/JP05/02460

§ 371 Date: Jul. 21, 2006

(30) Foreign Application Priority Data
Feb. 19, 2004 (JP) 2004-043049

(51) Int. Cl. B66B 11/08

(52) U.S. Cl. 187/254

(57) ABSTRACT

A machine room-less elevator, in which a car (2) raising and lowering along guide rails (4) and a counterweight (3) raising and lowering in the opposite direction of the car along a right or left side-surface or a rear surface of the car are driven by a hoist (11) provided at the top of a hoistway, includes first and second hoist ropes (7a), (7b) of two systems having one ends fixed to right and left sides of the car at positions nearly symmetrical with respect to a center of gravity of the car in a horizontal plane of the car and the other ends fixed to the counterweight, and one of the first and second hoist ropes is driven by the hoist.

### TECHNICAL FIELD

The present invention relates to a machine room-less elevator requiring no machine room in which a hoist is installed.

### BACKGROUND ART

There is conventionally known a so-called machine room-less elevator, which has no machine room installed at the top of a hoistway in view of a right of light, and in which a hoist or a drive sheave is divided into two systems to lower the top of the hoist way. There are provided an elevator in which a counterweight is provided on a rear surface side of a car when viewed from an entrance of a car (hereinafter, referred to as weight-falling-behind elevator) (see, for example, Patent Documents 1, 2), and an elevator in which a counterweight is provided on one of the right and left sides of the car when viewed from the entrance of the car (hereinafter, referred to as weight-falling-sidewise elevator) (see, for example, Patent Documents 3, 4).

Patent Document 1: JP 2001-261257 A

Patent Document 2: JP 11-157762 A

Patent Document 3: JP 11-106159 A

Patent Document 4: JP 10-167609 A

### DISCLOSURE OF THE INVENTION

Problem to be Solved by the Invention

In those conventional machine room-less elevators, because of the necessity for hoist ropes of two systems and also two drive sheaves, or the like, a construction of a hoist and an assembly for looping the hoist ropes are complicated. Further, there is, for example, a problem in that, to secure a space for installing a return sheave and a hoist, the top of a hoistway cannot be lowered.

It is an object of the present invention to realize a machine room-less elevator with a simpler structure.

Means for Solving the Problem

In view of the above object, the gist of the present invention relates to a machine room-less elevator in which a car raising and lowering along guide rails and a counterweight raising and lowering in an opposite direction of the car along a right or left side-surface or a rear surface of the car, are driven by a hoist provided at the top of a hoistway, including first and second hoist ropes of two systems having one ends fixed to right and left sides of the car at positions nearly symmetrical with respect to a center of gravity of the car in a horizontal plane of the car and the other ends fixed to the counterweight, characterized in that one of the first and second hoist ropes is driven by the hoist.

### Effect of the Invention

According to the present invention, a car suspending position of a car or the like is devised such that only one system of hoist ropes of two systems is driven by a hoist, thereby making it possible to provide a machine room-less elevator in which a hoist or the like has a simpler structure.

### BRIEF DESCRIPTION OF THE DRAWINGS

FIG. 1 A structural view of a machine-room less elevator according to Embodiment 1 of the present invention viewed downwards from a top of a hoistway.

FIG. 2 A side view viewed in a direction of an arrow of FIG. 1.

FIG. 3 A structural view of a machine-room less elevator according to Embodiment 2 of the present invention viewed downwards from the top of a hoistway.

FIG. 4 A side view viewed in a direction of an arrow of FIG. 3.

FIG. 5 A structural view showing a modification of Embodiment 2 of the present invention viewed downwards from the top of the hoistway.

FIG. 6 A structural view showing another modification of Embodiment 2 of the present invention viewed downwards from the top of the hoistway.

FIG. 7 A structural view of a machine-room less elevator according to Embodiment 3 of the present invention viewed downwards from the top of a hoistway.

FIG. 8 A side view viewed in a direction of an arrow of FIG. 7.

FIG. 9 A structural view of a machine-room less elevator according to Embodiment 4 of the present invention viewed downwards from the top of a hoistway.

FIG. 10 A side view viewed in a direction of an arrow of FIG. 9.

FIG. 11 A structural view showing a modification of Embodiment 4 of the present invention viewed downwards from the top of the hoistway.

FIG. 12 A structural view showing another modification of Embodiment 4 of the present invention viewed downwards from the top of the hoistway.

FIG. 13 A structural view of a machine-room less elevator according to Embodiment 5 of the present invention viewed downwards from the top of a hoistway.

FIG. 14 A side view viewed in a direction of an arrow of FIG. 13.

FIG. 15 A structural view of a machine-room less elevator according to Embodiment 6 of the present invention viewed downwards from the top of a hoistway.

FIG. 16 A side view viewed in a direction of an arrow of FIG. 15.

FIG. 17 A structural view showing a modification of Embodiment 6 of the present invention viewed downwards from the top of a hoistway.

FIG. 18 A structural view showing another modification of Embodiment 6 of the present invention viewed downwards from the top of the hoistway.

FIG. 19 A structural view of a machine-room less elevator according to Embodiment 7 of the present invention viewed downwards from the top of a hoistway.

FIG. 20 A side view viewed in a direction of an arrow of FIG. 19.

### BEST MODE FOR CARRYING OUT THE INVENTION

### Embodiment 1

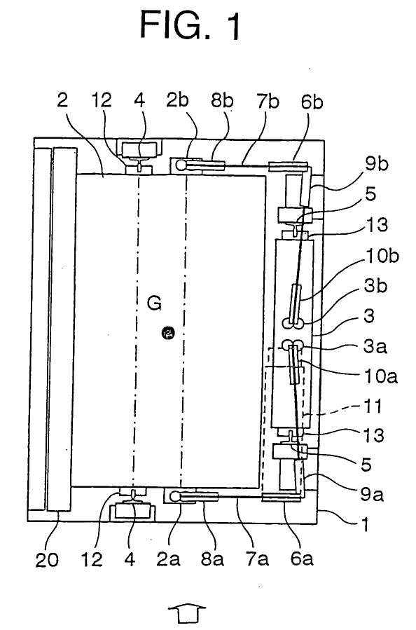

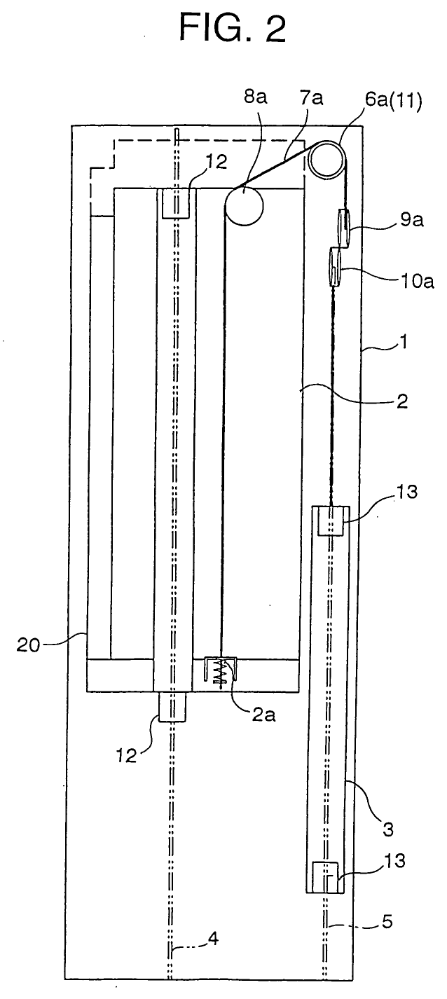

FIGS. 1 and 2 each show a construction of a machine room-less elevator according to Embodiment 1 of the present invention; FIG. 1 is a structural view viewed downwards from the top of a hoistway, and FIG. 2 is a side view viewed in a direction of an arrow of FIG. 1. In the hoistway 1, hoist ropes 7a, 7b of two systems are respectively fixed, at one ends thereof, to car suspending points 2a, 2b provided on either side of a car 2, and are respectively fixed, at the other ends thereof, to weight suspending points 3a, 3b provided on a center of gravity of a counterweight 3. The hoist ropes 7a, 7b are looped around deflector sheaves 8a and 8b, a drive sheave 6a and a sheave 6b, and return sheaves 9a, 9b, 10a, 10b, respectively. Here, the deflector sheaves 8a, 8b are provided at the top of the hoistway above the car suspending points 2a, 2b, and serve to increase a winding angles of the hoist ropes with respect to the drive sheave 6a and the sheave 6b, and to bring a line connecting car suspending points 2a, 2b to each other close to a center of gravity position in a horizontal plane of the car denoted by reference symbol G as shown in FIG. 1. Note that, a fact that the line connecting two positions to each other passes near the center of gravity position G indicates that those two positions are nearly symmetrical with respect to the center of gravity. The drive sheave 6a and the sheave 6b are arranged at the top of the hoistway and outside of a horizontal projection plane of the car, and in an area where the counterweight 3 is raised and lowered, that is, a rear surface side of the car when viewed from a car door 20, so as to have a rotation axis parallel to the deflector sheaves 8a, 8b. Further, in FIG. 1, the return sheaves 9a, 9b, 10a, 10b are arranged so as to connect respectively between end points of the drive sheave 6a and sheave 6b, and the weight suspending points 3a, 3b in a line. The drive sheave 6a is driven by a hoist 11 (which is indicated in the drawings by a dashed line because it overlaps with structures such as the counterweight and the hoist rope, and hereinafter shown in the same way) which is provided at the top of the hoistway and outside of the horizontal projection plane region in which the car 2 is raised and lowered, and on a side where the counterweight 3 is raised and lowered.

The counterweight 3 is located on the rear surface side when viewed from an entrance provided for the hoistway and the car. The car 2 and the counterweight 3 are respectively supported by guides 12, 13, which are respectively provided on upper, lower, left, or right portions (four corners), on guide rails 4 and guide rails 5. The car 2 is guided by a pair of guide rails 4, the counterweight 3 is guided by a pair of guide rails 5. A line connecting tips of the pair of guide rails 4 to each other passes the vicinity of the center of gravity of the car G (hereinafter, referred to as the same) provided in the horizontal plane of the car. The pair of guide rails 4 are provided such that the center of gravity of the car G is present between the line as described above and the line connecting the car suspending points 2a, 2b to each other. Loads on the deflector sheaves 8a, 8b, the drive sheave 6a, the sheave 6b, the return sheaves 9a, 9b, 10a, 10b, and the hoist 11 are supported by the guide rails 4, 5.

A car position indicated by a dashed line of FIG. 2, is an upper arrival limit of the car. The hoist 11 is structured so as to be equal to or smaller in outer diameter than the drive sheave 6a, indicating that, even if the car arrives at the upper limit, no interference occurs.

Conventionally, in the case of an elevator having ropes of two systems, since drive force is applied to both ropes, so a structure is complicated, for example, a plurality of hoists are required, or one motor drives two drive sheaves. Therefore, in this embodiment, there is provided a structure in which a sufficient traction ability is ensured only by one of the hoist ropes of two systems, and the other system needs no traction ability. To be specific, a torque of the hoist is transmitted only to the drive sheave 6a, and 6b is made to simply be a sheave. In this case, although suspension loads on the left and right of the car differs from each other, by increasing the strength of the guide 12 (for example, using a H-shaped rail and a C-shaped guide described later), and widening a load supporting region (selecting the car suspending point, or the like), the car can be raised and lowered in a well-balanced manner.

### Embodiment 2

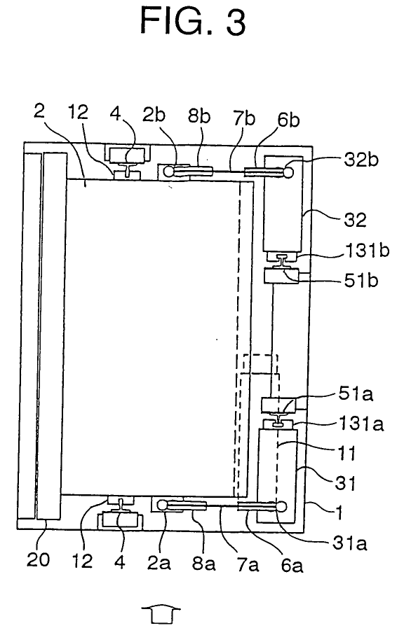

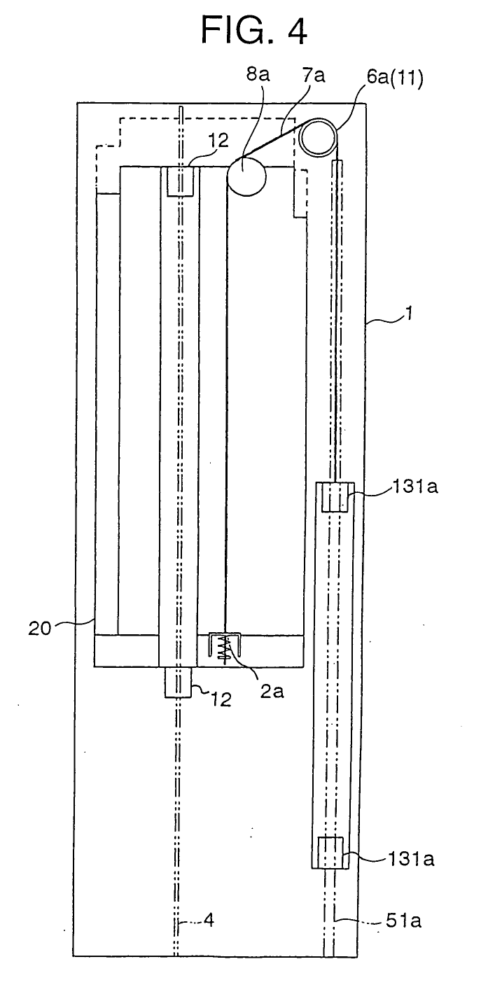

FIGS. 3 and 4 each show a construction of a machine room-less elevator according to Embodiment 2 of the present invention; FIG. 3 is a structural view viewed downwards from the top of a hoistway; and FIG. 4 is a side view viewed in a direction of an arrow of FIG. 3. In the figures, portions which are the same as or corresponding to those of Embodiment 1 are denoted by the same reference symbols, and the description thereof is omitted. In this embodiment, a counterweight is divided into two, counterweights 31, 32, and both of them are arranged so as to be opposed to at least one of hoistway walls. Weight suspending points 31a, 32b are provided so as to locate vertically below the drive sheave 6a and the sheave 6b, respectively. Further, the counterweights 31, 32 are respectively guided by a single guide rail 51a and a single guide rail 51b to be raised and lowered. Here, each of the guide rails 51a, 51b is an H-shaped rail which has a larger rail head portion abutting on a guide than that of a conventional T-shaped rail. Further, guides 131a, 131b of the counterweights are C-shaped guides covering the rail head, and a rotation moment of the counterweights 31, 32 generated due to a tension of the hoist ropes 7a, 7b can be supported on the front, back, left, and right sides while raising and lowering the counterweights 31, 32.

Further, in this embodiment, the hoist 11 is provided so as to partially overlap with the horizontal projection plane of the car 2, and when the car 2 arrives at the upper limit within a movable area in the hoistway (indicated by a dashed line in FIG. 4), a part of the car interferes with an apparatus provided at the top of the hoistway such as the hoist. Thus, an upper portion of the car which interferes with the hoist is cut out. The upper portion of the car is formed of a cage for accommodating passengers, a reinforcing member for supporting the cage, various additional apparatuses, and the like. Depending on the size of the apparatus interfering with the car, portion of the car above the cage may be cut out, and the cage itself may be cut out. In cutting out the cage itself, to avoid affecting on a space for accommodating passengers, the portion to be cut out is limited to the minimum, for example, to only a ceiling portion.

The elevator according to this embodiment is structured as described above, unlike in Embodiment 1, running of a rope by means of the return sheave is little, the rope is simple in structure and is short. Further, the car is cut out, thereby making it possible to lower the top of the hoistway, increasing a degree of freedom for a design of the hoist or the like and also for an arrangement of apparatuses, and saving space.

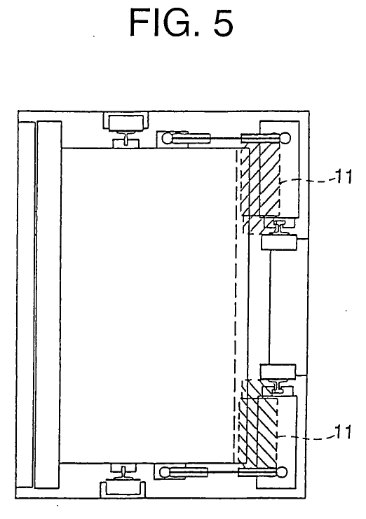

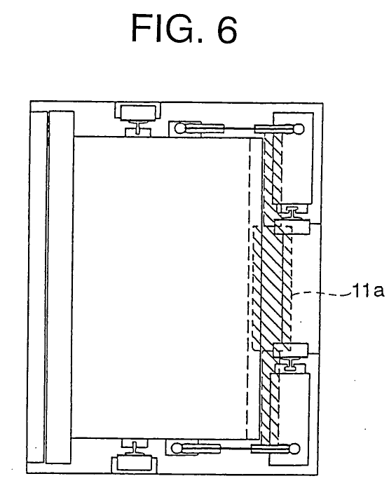

In this embodiment, while the hoist 11 is configured to drive only the drive sheave 6a, it is also possible to drive only the sheave 6b, to drive the sheave 6b with two hoists as shown in FIG. 5, or to arrange the drive sheave 6a and the sheave 6b in the same axis to drive those with a single motor (hoist) 11a as shown in FIG. 6.

### Embodiment 3

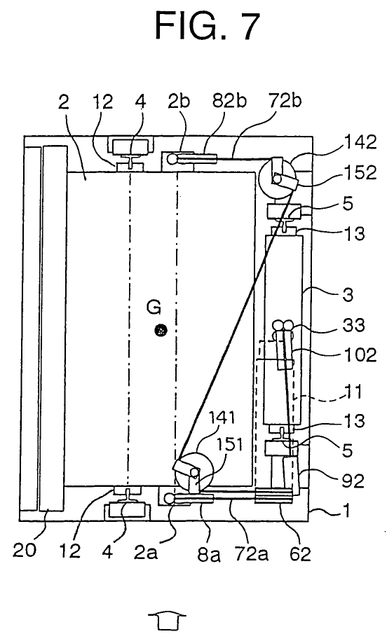

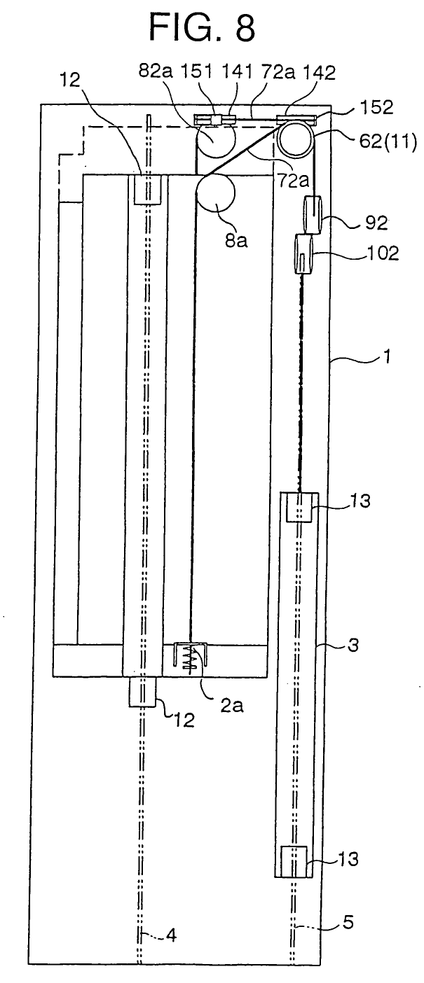

FIGS. 7 and 8 each show a construction of a machine room-less elevator according to Embodiment 3 of the present invention; FIG. 7 is a structural view viewed downwards from the top of the hoist, FIG. 8 is a side view viewed in a direction of an arrow of FIG. 7. In the figures, portions which are the same as or corresponding to those of the above embodiments are denoted by the same reference symbols, and the description thereof is omitted. Hoist ropes 72a, 72b of two systems are respectively fixed, at one ends thereof, to car suspending points 2a, 2b provided on either side of the car 2, and are fixed, at the other ends thereof, to a weight suspending point 33 provided on a center of gravity of the counterweight 3. The hoist rope 72a is looped around the deflector sheave 8a, a drive sheave 62, and return sheaves 92, 102. The hoist rope 72b is looped around the drive sheave 62, and return sheaves 92, 102 via a deflector sheave 82b, horizontal sheaves (return sheaves) 142, 141. Therefore, from the drive sheave 62 to the weight suspending point 33, the hoist rope 72b passes through the same route as that of the hoist rope 72a.

The deflector sheave 82b is provided at the top of the hoistway above the car suspending point 2b, and serves to bring the line connecting the car suspending points 2a, 2b to each other close to the center of gravity position of the car denoted by reference symbol G as shown in FIG. 7. A drive sheave 62 is provided at the top of the hoistway and outside of the horizontal projection plane of the car, and in the area where the counterweight 3 is raised and lowered, that is, the rear surface side of the car when viewed from the car door 20, so as to have a rotation axis parallel to the deflector sheave 8a, and is driven by the hoist 11. Further, as shown in FIG. 7, return sheaves 92, 102 are arranged so as to connect an end point of the drive sheave 62 and a weight suspending point 33 to each other in a line. Horizontal sheaves 141, 142 are arranged so as to have an axis above the upper arrival limit of the car at the top of the hoistway in a vertical direction, and serve to guide a hoist rope 72b passing on the drive sheave 62 to the deflector sheave 82b through the vicinity of the ceiling of the hoistway. The horizontal sheaves 141, 142 are respectively provided with latches 151, 152 such that even if the car or the counterweight hits a buffer positioned at a bottom of the hoistway and the tension of the hoist rope is released, the rope does not come off from a groove in the sheave. Loads on the deflector sheaves 8a, 82b, the drive sheave 62, the horizontal sheaves 141, 142, the return sheaves 92, 102, and the hoist 11 are supported by the guide rails 4, 5.

In an elevator having suspending points on the opposite sides of the car, the elevator can be driven by a single drive sheave, thereby simplifying a structure of a hoist.

In this embodiment, there can only be ensured the winding angle of only 90° of the hoist rope 72b with respect to the drive sheave 62. Therefore, it is required to ensure a sufficient traction ability by using the hoist rope having a higher coefficient of friction such as a resin-covered rope than a conventional steel rope. Further, as in Embodiment 1, it is also possible to separately form a portion of the drive sheave 62, on which the hoist rope 72b is looped around, as another sheave to make the sheave rotatable with respect to a drive shaft of the hoist 11 through the intermediation of a bearing, for example, thereby avoiding the drive force to be transmitted.

### Embodiment 4

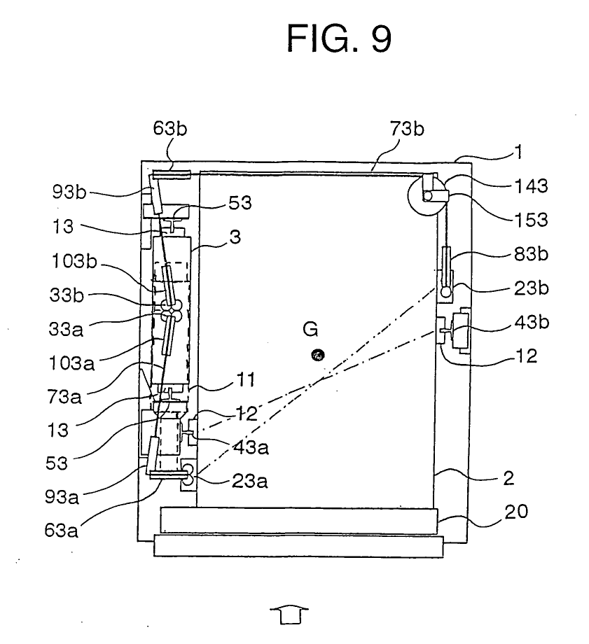

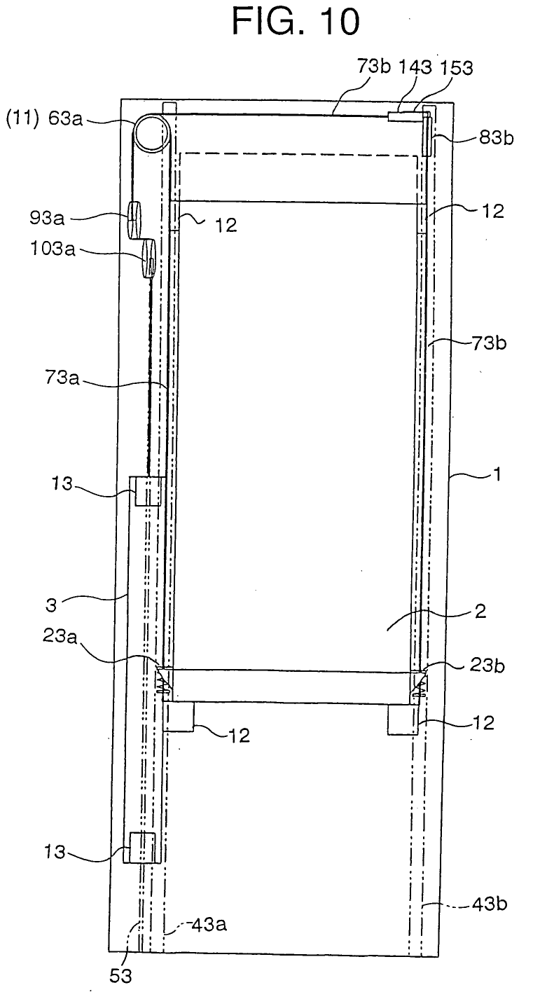

FIGS. 9 and 10 each show a construction of a machine room-less elevator according to Embodiment 4 of the present invention; FIG. 9 is a structural view viewed downwards from the top of the hoist, FIG. 10 is a side view viewed in a direction of an arrow of FIG. 9. In the figures, portions which are the same as or corresponding to those of the above embodiments are denoted by the same reference symbols, and the description thereof is omitted. Hoist ropes 73a, 73b of two systems are respectively fixed, at one ends thereof, to car suspending points 23a, 23b provided on either side of the car 2, and are respectively fixed, at the other ends thereof, to weight suspending points 33a, 33b provided on a center of gravity of the counterweight 3. The hoist rope 73a is looped around a drive sheave 63a, and return sheaves 93a, 103a. The hoist rope 73b is looped around a deflector sheave 83b, a horizontal sheave (return sheave) 143, a sheave 63b, and return sheaves 93b, 103b. The car suspending points 23a, 23b are arranged diagonally with respect to the car such that the line connecting the car suspending points 23a, 23b to each other passes the vicinity of the center of gravity of the car G. That is, the car suspending points 23a, 23b are arranged such that a line connecting those to each other passes the vicinity of the center of gravity of the car G, and they are close to positions having point symmetry with respect to the center of gravity of the car G, and are diagonal with respect to the car. Further, guide rails 43a, 43b for guiding the car 2 are also arranged diagonally with respect to the car in positions closer, in the horizontal projection plane, to the center of the car than the car suspending points, such that a line connecting rail ends thereof to each other passes the vicinity of the center of gravity of the car G. That is, the guide rails 43a, 43b are also arranged in the positions diagonal with respect to the car, where the line connecting those to each other passes the vicinity of the center of gravity of the car G, the positions being near the positions having point symmetry with respect to the center of gravity of the car G, and being closer to the center of the car than the car suspending points.

Here, the deflector sheave 83b is provided at the top of the hoistway above the car suspending point 23b, and serves to bring the line connecting the car suspending points 23a, 23b to each other close to the center of gravity position of the car denoted by reference symbol G as shown in FIG. 9. The horizontal sheave 143 is provided so as to have an axis above the upper arrival limit of the car at the top of the hoistway in a vertical direction, and serves to guide a hoist rope 73b passing on the sheave 63b to the deflector sheave 83b through the vicinity of the ceiling of the hoistway. Further, the horizontal sheave 143 is provided with a latch 153 such that even if the car or the counterweight hits a buffer (not shown) positioned at a bottom of the hoistway and the tension of the hoist rope is released, the rope does not come off from a groove in the sheave. The drive sheave 63a is provided at the top of the hoistway and outside of the horizontal projection plane of the car, and in the area where the counterweight 3 is raised and lowered, that is, the lateral surface side of the car when viewed from the car door 20 (in the figure, while there is exemplarily shown the case where the counterweight is provided on the left side, the counterweight may be provided either of the right or left side), so as to have a rotation axis parallel to a longitudinal direction of the counterweight, that is, to a depth direction of the car of FIG. 9. Further, return sheaves 93a, 93b, 103a, 103b are arranged so as to respectively connect the drive sheave 63a and sheave 63b, and the weight suspending points 33a, 33b to each other in a line as shown in FIG. 9. Loads on the deflector sheave 83b, the drive sheave 63a, the horizontal sheave 143, the sheave 63b, the return sheaves 93a, 93b, 103a, 103b, and the hoist 11 are supported by guide rails 43a, 43b, 53. The drive sheave 63a is driven at the top of the hoistway by the hoist 11 (indicated by a dashed line in the figure) provided outside of the horizontal projection plane region in which the car 2 is raised and lowered, and on the side where the counterweight 3 is raised and lowered.

The elevator according to this embodiment is structured as described above, and the hoist rope is provided in the vicinity of the ceiling of the hoistway by means of the horizontal sheave having a rotation axis in a vertical direction, thereby making it possible to reduce the height of the hoistway as compared to the conventional elevator in which the counterweight is provided on the car lateral surface. Further, the car guide rails 43a, 43b are arranged diagonally with respect to the car, the position of the guide rail 43a gets close to the front side of the hoistway (entrance 20 side), so the rail span of the guide rail 53 for the counterweight 3 can be increased. As a result, the length of the counterweight in the longer lateral (depth) direction increases, thereby making it possible to reduce the lateral width or the length in the vertical direction of the weight for securing the same weight. The smaller the lateral width of the counterweight becomes, the smaller the plane space becomes, and the smaller the length in the vertical direction becomes, the smaller the height of the hoistway becomes.

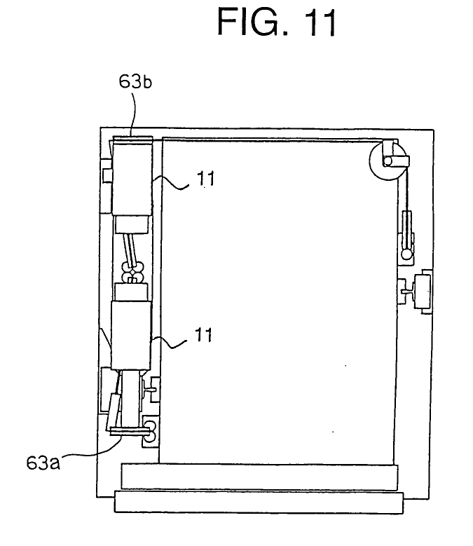

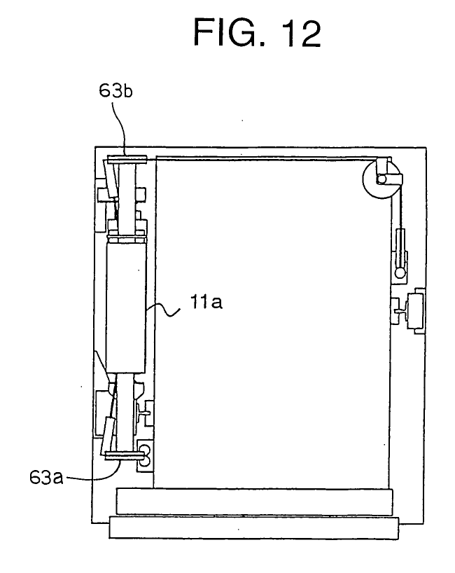

In this embodiment, the hoist 11 is configured to drive only the drive sheave 63a. It is also possible to drive the sheave 63b as well with two hoists (each indicated by a solid line) as shown in FIG. 11, or to arrange the drive sheave 63a and the sheave 63b on the same axis to drive those with a single motor (hoist) 11a as shown in FIG. 12. Only the sheave 63b may be driven, and in that case, the winding angle of the hoist rope 73b with respect to the sheave 63b is equal to or less than 90°, so it is required to ensure a sufficient traction ability by using the hoist rope having a higher coefficient of friction such as a resin-covered rope than a conventional steel rope.

### Embodiment 5

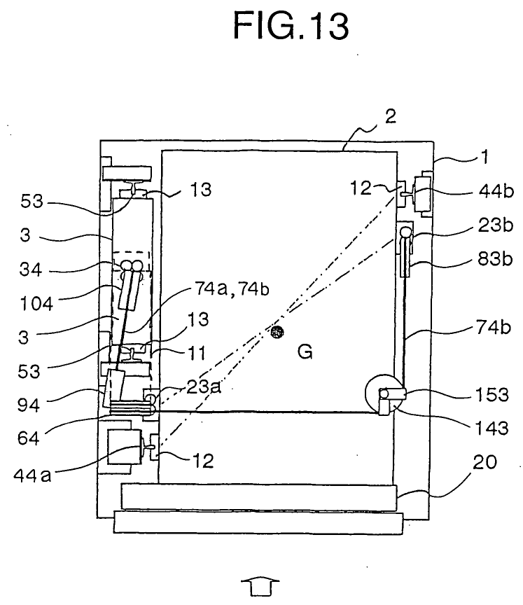

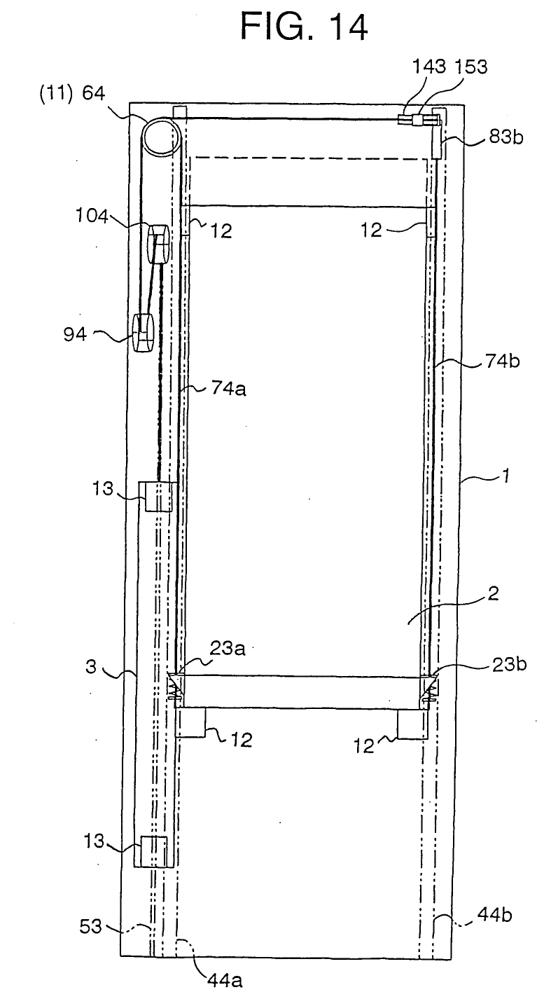

FIGS. 13 and 14 each show a construction of a machine room-less elevator according to Embodiment 5 of the present invention; FIG. 13 is a structural view viewed downwards from the top of the hoist, FIG. 14 is a side view viewed in a direction of an arrow of FIG. 13. In the figures, portions which are the same as or corresponding to those of the above embodiments are denoted by the same reference symbols, and the description thereof is omitted. Hoist ropes 74a, 74b of two systems are respectively fixed, at one ends thereof, to car suspending points 23a, 23b provided on either side of the car 2, and are respectively fixed, at the other ends thereof, to a weight suspending points 34 provided on a center of gravity of the counterweight 3. The hoist rope 74a is looped around a drive sheave 64, and return sheaves 94, 104. The hoist rope 74b is looped around a deflector sheave 83b, a horizontal sheave 143, a drive sheave 64, and return sheaves 94, 104. Therefore, from the drive sheave 64 to the weight suspending point 34 of the counterweight 3, the hoist rope 74b pass through the same route as that of the hoist rope 74a. The car suspending points 23a, 23b are arranged diagonally with respect to the car such that the line connecting those to each other passes the vicinity of the center of gravity of the car G. That is, the car suspending points 23a, 23b are arranged such that a line connecting those to each other passes the vicinity of the center of gravity of the car G, and they are close to positions having point symmetry with respect to the center of gravity of the car G, and are diagonal with respect to the car. Further, guide rails 44a, 44b for guiding the car 2 are also arranged in positions farther from the center of the car than the car suspending points, such that a line connecting rail ends thereof to each other passes the vicinity of the center of gravity of the car G. That is, the guide rails 44a, 44b are also arranged in the positions diagonal with respect to the car, where the line connecting those to each other passes the vicinity of the center of gravity of the car G, the positions being near the positions having point symmetry with respect to the center of gravity of the car G, and being farther from the center of the car than the car suspending points.

The drive sheave 64 is provided at the top of the hoistway and outside of the horizontal projection plane of the car, and on the lateral surface side of the car where the counterweight is raised and lowered when viewed from the entrance (in the figure, while there is exemplarily shown the case where the counterweight is provided on the left side, the counterweight may be provided either of the right and left sides), so as to have a rotation axis parallel to a longitudinal direction of the counterweight, that is, to a depth direction of the car of FIG. 13. Further, return sheaves 94, 104 are arranged so as to connect an end point of the drive sheave 64 and the weight suspending point 34 to each other in a line as shown in FIG. 13. Loads on the deflector sheave 83b, the drive sheave 64, the horizontal sheave 143, the return sheaves 94, 104, and the hoist 11 are supported by guide rails 44a, 44b, 53. The drive sheave 64 is driven at the top of the hoistway by the hoist 11 (indicated by a dashed line in the figure) provided outside of the horizontal projection plane region in which the car 2 is raised and lowered, and on the side where the counterweight 3 is raised and lowered.

According to the elevator of this embodiment, the elevator having suspending points at either side of the car can be driven by a single drive sheave, thereby simplifying the structure of the hoist. Further, the elevator according to this embodiment is structured as described above, and the hoist rope is provided in the vicinity of the ceiling of the hoistway by means of the horizontal sheave having a rotation axis in the vertical direction, thereby making it possible to reduce the height of the hoistway as compared to the conventional elevator in which the counterweight is provided on the car lateral surface. Further, the car guide rails 44a, 44b are arranged diagonally with respect to the car, so the position of the guide rail 44a gets close to the front side of the hoistway (entrance 20 side), and the rail span of the guide rail 53 for the counterweight 3 can be increased. As a result, the length of the counterweight in the longer lateral (depth) direction increases, thereby making it possible to reduce the lateral width or the length in the vertical direction of the weight for securing the same weight. The smaller the lateral width of the counterweight becomes, the smaller the plane space becomes, and the smaller the length in the vertical direction becomes, the smaller the height of the hoistway becomes.

In this embodiment, there can only be ensured the winding angle of 90° of the hoist rope 74b with respect to the drive sheave 64. Therefore, it is required to ensure a sufficient tractionability by using the hoist rope having a higher coefficient of friction such as a resin-covered rope than a conventional steel rope. Further, as in Embodiment 1, it is also possible to separately form a portion of the drive sheave 64, on which the hoist rope 74b is looped around, as another sheave to make the sheave rotatable with respect to the drive shaft of the hoist 11 through the intermediation of a bearing, for example, thereby avoiding the drive force to be transmitted.

### Embodiment 6

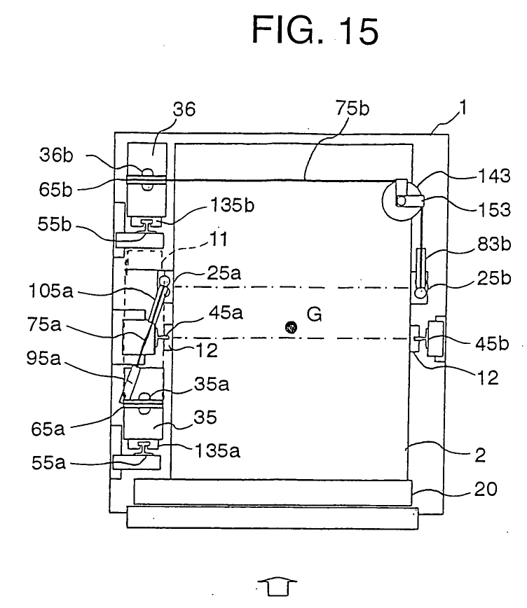

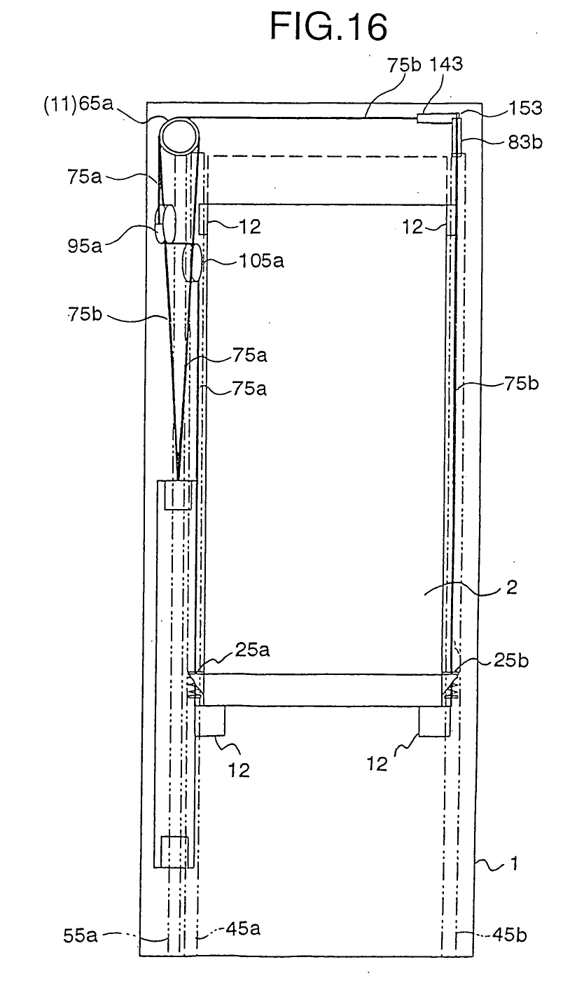

FIGS. 15 and 16 each show a construction of a machine room-less elevator according to Embodiment 6 of the present invention; FIG. 15 is a structural view viewed downwards from the top of the hoist, FIG. 16 is a side view viewed in a direction of an arrow of FIG. 15. In the figures, portions which are the same as or corresponding to those of the above embodiments are denoted by the same reference symbols, and the description thereof is omitted. In this embodiment, a counterweight is divided in to two, counterweights 35, 36, and both of them are arranged so as to be opposed to at least one of hoistway walls on the lateral surface when viewed from the car entrance 20 (in the figure, while there is exemplarily shown the case where the counterweight is provided on the left side, the counterweight may be provided either of the right and left sides). Weight suspending points 35a, 36b are provided so as to locate vertically below the drive sheave 65a and the sheave 65b, respectively. Hoist ropes 75a, 75b of two systems are respectively fixed, at one ends thereof, to car suspending points 25a, 25b provided on either side of the car 2, and are respectively fixed, at the other ends thereof, to weight suspending points 35a, 36b of the counterweights 35, 36, respectively. The hoist rope 75a is looped around the drive sheave 65a, and return sheaves 95a, 105a. The hoist rope 75b is looped around the sheave 65b, the horizontal sheave 143, and the deflector sheave 83b.

Further, the counterweights 35, 36 are respectively guided by a single guide rail 55a and a single guide rail 55b to be raised and lowered. Here, each of the guide rails 55a, 55b is an H-shaped rail which has a larger rail head portion abutting on a guide than that of a conventional T-shaped rail. Guides 135a, 135b for the counterweight are C-shaped guides covering the rail head, and a rotation moment of the counterweights 35, 36 generated due to a tension of the hoist ropes 75a, 75b can be supported from the front, back, left, and right sides while raising and lowering the counterweights 35, 36.

The car suspending points 25a, 25b and the guide rails 45a, 45b for guiding the car 2 are arranged such that lines respectively connecting those to each other are parallel to a side on which the entrance is provided, the center of gravity of the car G exists between those lines, and the lines pass the vicinity of G.

The deflector sheave 83b is provided at the top of the hoistway above the car suspending point 25b, and serves to bring the line connecting the car suspending points 25a, 25b to each other close to the center of gravity position of the car denoted by reference symbol G as shown in FIG. 15. The drive sheave 65a is provided at the top of the hoistway and outside of the horizontal projection plane of the car, and on the lateral surface side of the car where the counterweight is raised and lowered when viewed from the car door 20 (in the figure, while there is exemplarily shown the case where the counterweight is provided on the left side, the counterweight may be provided either of the right and left sides), so as to have a rotation axis parallel to a longitudinal direction of the counterweight, that is, to a depth direction of the car of FIG. 15. Further, return sheaves 95a, 105a are arranged so as to connect the drive sheave 65a and the weight suspending point 25a to each other in a line as shown in FIG. 15. Loads on the deflector sheave 83b, the horizontal sheave 143, the sheave 65b, the drive sheave 65a, the return sheaves 95a, 105a, and the hoist 11 are supported by guide rails 45a, 45b, 55a, 55b. The drive sheave 65a is driven at the top of the hoistway by the hoist 11 (indicated by a dashed line in the figure) provided outside of the horizontal projection plane region in which the car 2 is raised and lowered, and on the side where the counterweights 35, 36 are raised and lowered.

The elevator of this embodiment is structured as described above, so unlike in Embodiment 4, running of a rope by means of the return sheave is little, the rope is simple in structure and is short. Further, since the counterweight is divided, the car guide rails can be arranged close to the center of gravity of the car and parallel to the car door 20.

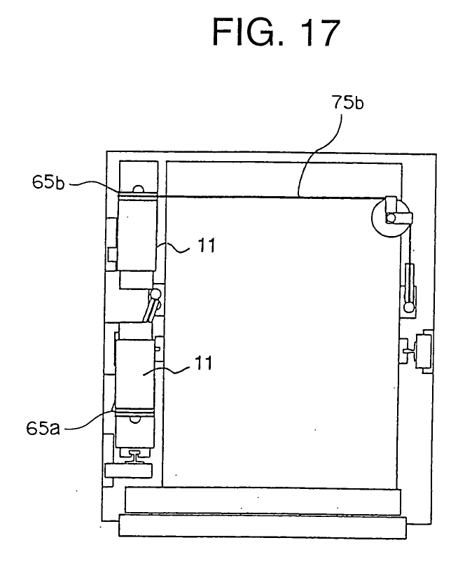

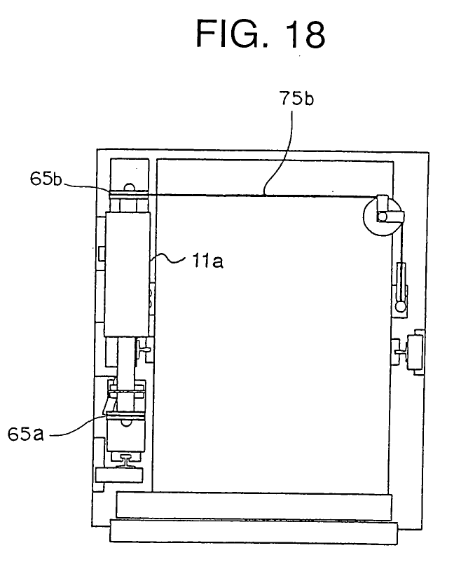

In this embodiment, the hoist 11 is configured to drive only the drive sheave 65a. It is also possible to drive both the drive sheave 65a and the sheave 65b with two hoists 11 (each indicated by a solid line) as shown in FIG. 17, or to arrange the drive sheave 65a and the sheave 65b on the same axis to drive those with a single motor (hoist) 11a as shown in FIG. 18. Only the sheave 65b may be driven, and in that case, the winding angle of the hoist rope 75b with respect to the sheave 65b is equal to or less than 90°, so it is required to ensure a sufficient traction ability by using a hoist rope having a higher coefficient of friction such as a resin-covered rope than a conventional steel rope.

### Embodiment 7

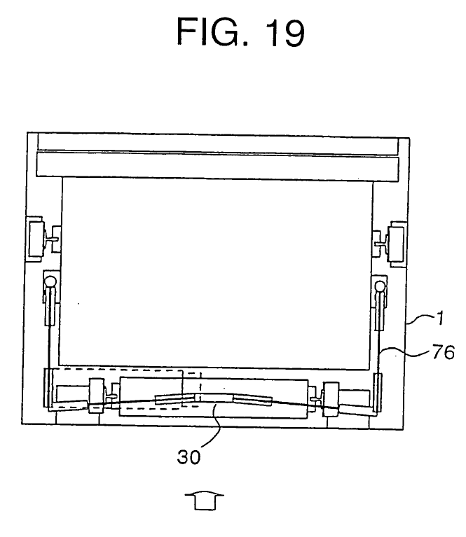

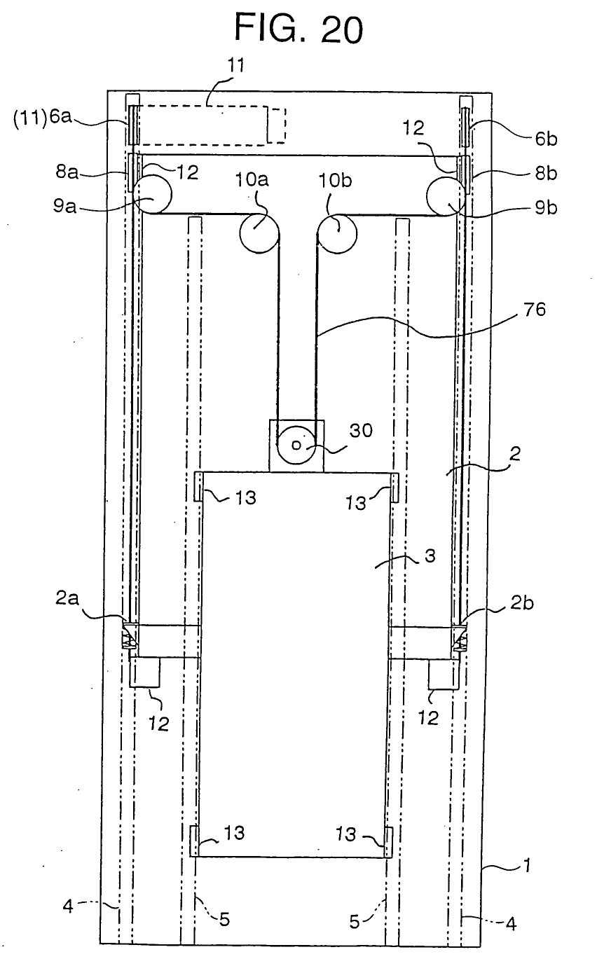

FIGS. 19 and 20 each show a construction of a machine room-less elevator according to Embodiment 7 of the present invention; FIG. 19 is a structural view viewed downwards from the top of the hoist, FIG. 20 is a side view viewed in a direction of an arrow of FIG. 19. In the figures, portions which are the same as or corresponding to those of the above embodiments are denoted by the same reference symbols, and the description thereof is omitted. FIG. 19 is the same as FIG. 1 except for a point in which a hoist rope 76 is shown as of one system and a point in which the counterweight 3 is shown as being supported by a suspension sheave 30. The suspension sheave 30 is provided with the counterweight 3, and the hoist rope 76 is looped around the suspension sheave to support the counterweight without being fixed to the counterweight. The hoist rope 76 having one end fixed to the support portion 2a of the car, is looped around the drive sheave 6a via the deflector sheave 8a, is changed in direction at the two return sheaves 9a, 10a to be looped around the suspension sheave 30 on the counterweight, and is fixed to the support portion 2b of the car at the other end thereof via the return sheaves 10b, 9b, the sheave 6b, and the deflector sheave 8b as described above.

With the construction as described above, a hoist rope becomes of one system. The hoist rope is elongated over time. The elongation is not constant due to variation of hoist ropes in terms of variation in manufacture or the like. Accordingly, in the case of hoist ropes of two systems, when the raising/lowering takes longer, the difference in elongation becomes larger, thereby causing the car to be inclined. Time and effort for adjusting this is then required. By making the hoist rope be of one system, the running cost required for maintenance can be reduced.

In the above exemplary case, while the suspension sheave 30 is provided on the top of the counterweight, the suspension sheave 30 may be provided on the bottom thereof. Further, in the above exemplary case, while the suspension sheave is provided on the counterweight, the suspension sheave may be provided on the car.

In this embodiment, the suspension sheave 30 for the counterweight is added to the construction of Embodiment 1, to make the ropes of two systems be of one system. In Embodiments 3, 4, 5, the same effect can be obtained by providing the suspension sheave on the counterweight to make the ropes of two systems be of one system.

The present invention is not limited to the embodiments as described above, and includes possible combinations of the embodiments. The gist of the present invention is to simplify a structure of a hoist or a looping structure of hoist ropes, and to lower the top of a hoistway by, for example, driving one of hoist ropes of two systems by a hoist, structuring counterweights by two counterweights each of which are guided by a single guide rail, using return sheave pivoted about a vertical shaft particularly at the top of a hoistway, cutting out a portion of a car interfering with the hoist when the car arrives at the upper limit in the hoistway, providing, in an elevator in which a counterweight is provided on the left or right side of lateral surface sides, a drive sheave on which a hoist rope is looped around such that an axial direction thereof coincides with a depth direction of a car, and providing a suspension sheave on the counterweight and looping a hoist rope having one end fixed to either of the left or right sides of the car and the other end fixed to a position on the opposite side of the car around a first drive sheave, the suspension sheave, and a second derive sheave in the stated order such that the other end locates to be substantially symmetrical to the one end with respect to the center of gravity of the car.

1. A machine room-less elevator in which a car raising and lowering along guide rails and a counterweight raising and lowering in an opposite direction of the car along a right or left side-surface or a rear surface of the car are driven by a hoist provided at a top of a hoistway, comprising first and second hoist ropes of two systems having one ends fixed to right and left sides of the car at positions nearly symmetrical with respect to a center of gravity of the car in a horizontal plane of the car and another ends fixed to the counterweight, wherein one of the first and second hoist ropes is driven by the hoist.

2. The machine room-less elevator according to claim 1, wherein the first and second hoist ropes are fixed, at the another ends thereof, together to the counterweight.

3. The machine room-less elevator according to claim 1, wherein the counterweight comprises a first and second counterweights each of which is guided by a single guide rail; and the another ends of the first and second hoist ropes are fixed to the first and second counterweights, respectively.

4. The machine room-less elevator according to claim 3, wherein the first and second counterweights are each provided on opposite sides on the lateral surface side or the rear surface side of the car in the hoistway so that guide rails for each counterweights are provided therebetween.

5. The machine room-less elevator according to claim 1, wherein a direction and a position of at least one system of the hoist ropes are changed by a return sheave pivotally supported by a vertical shaft at the top of the hoistway.

6. The machine room-less elevator according to claim 5, wherein the first and second hoist ropes are driven by the same hoist.

7. The machine room-less elevator according to claim 5, comprising the two hoists, wherein the first and second hoist ropes are driven by different hoists.

8. The machine room-less elevator according to claim 1, wherein a portion of the car interfering with the hoist in a case where the car arrives at an upper limit in the hoistway is cut out.

9. The machine room-less elevator according to claim l, comprising the two guide rails for guiding the car, wherein the two guide rails are arranged in positions close to positions having point symmetry with respect to the center of gravity of the car in the horizontal plane of the car, and diagonal with respect to the car.

10. The machine room-less elevator according to claim 9, wherein the first and second hoist ropes are driven by the same hoist.

11. The machine room-less elevator according to claim 9, comprising the two hoists, wherein each of the first and second hoist ropes is driven by the different hoists.

12. A machine room-less elevator in which a car raising and lowering along guide rails and a counterweight raising and lowering in an opposite direction of the car along a right or left side-surface or a rear surface of the car are driven by a hoist provided at a top of a hoistway, wherein a suspension sheave is provided on the counterweight; and a hoist rope is provided, which has one end fixed to right or left side-surface of the car and another end fixed to a position substantially symmetrical to the one end on an opposite side of the car with respect to a center of gravity of the car in a horizontal plane, so that the hoist rope is looped around a first drive sheave, the suspension sheave, and a second drive sheave in the stated order.
